(19) United States
(12) Patent Application Publication
(10) Pub. No.: US 2004/0093270 A1
(43) Pub. Date: May 13, 2004

(54) Method and system for amplifying advertisements

(76) Inventor: Hugh Heathcote Gilbert, Dalham (GB)

Correspondence Address: HOWSON AND HOWSON, ONE SPRING HOUSE CORPORATION CENTER, BOX 457, 321 NORRISTOWN ROAD, SPRING HOUSE, PA, 19477, US

(21) Appl. No.: 10/699,245

(22) Filed: Oct. 31, 2003

Related U.S. Application Data
(63) Continuation of application No. 09/608,371, filed on Jun. 30, 2000, now abandoned.

(51) Int. Cl. G06F 17/60

(52) U.S. Cl. 705/14

(57) ABSTRACT

Disclosed is a method and system for facilitating the retrieval of information concerning products and/or services provided by a plurality of mutually unrelated providers. A single website, accessible by consumers, includes means for retrieving said information. The address of the website may be included in each of a plurality of advertisements for the respective products and/or services. The information may be retrieved by means of hyperlinks to websites of the providers. Details of consumers retrieving the information are logged in a database.

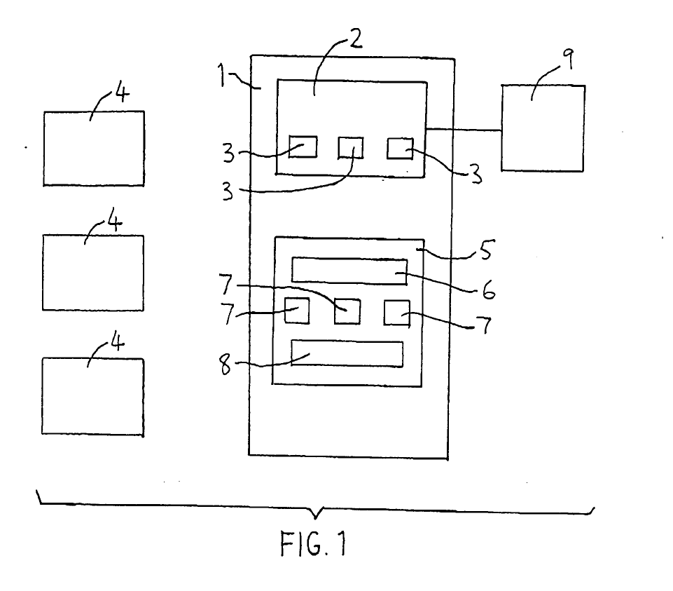

### BACKGROUND TO THE INVENTION

The present invention relates to a method and a system for facilitating the retrieval by consumers of further information relating to products and/or services advertised via a medium such as television, radio, and the press.

Television advertisements are necessarily short and punchy. Further information is normally advertised as being available from the company's website, brochure etc.

The first time one sees an advertisement it is difficult to remember the information conveyed about the product or service, let alone the contact number or website.

In a period of viewing a multiplicity of websites, contact numbers will be advertised, all easily forgotten.

Even if web site addresses are remembered it is frequently the case that the address given is that of the company website and does not bear any relation to the particular promotion.

Website addresses, even when remembered are easily misspelled or have the wrong suffix. It is also possible to find oneself viewing an unofficial or fraudulent website instead of the desired official website.

Often, advertisements are entertaining in themselves and it would frequently be interesting to know the title of the accompanying music or the location.

### SUMMARY OF THE INVENTION

It is an object of the invention to provide a one-stop website for information on all advertised products.

It is a further object of the invention to provide a database of information concerning advertisements themselves.

Accordingly, the present invention provides a method of facilitating the retrieval of information concerning products and/or services provided by a plurality of mutually unrelated providers, comprising providing a single internet site including means for retrieving said information, said internet site being accessible by consumers, and the address of said internet site optionally being included in each of a plurality of advertisements for the respective products and/or services.

In the preferred embodiment of the inventive method, the information retrieval means operates when a consumer identifies a brand name or, for example by means of one or more keywords, part of the content of an advertisement. If the consumer's input is specific, only information concerning the specific product or service is retrieved, i.e. the hyperlinks are “tight”. If the consumer's input is not specific to one advertisement, product or service, then information concerning a range of products and/or services is retrieved.

The providers subscribe to the internet site and may be charged for the subscription. Having subscribed, the providers may optionally include information identifying said internet site, such as the address thereof, in their advertisements.

Said means for retrieving the information may comprise a plurality of hyperlinks to websites of the providers, i.e. said internet site may comprise a portal. Alternatively or additionally, said internet site may include information concerning the products and services.

In the most preferred embodiment, a consumer wishing to retrieve said information is required to input personal details including at least his or her name and e-mail address, and said details are added to a database. Preferably, consumers in the database are categorized according to their products or services of interest.

Preferably, the method includes presenting any consumer attempting to retrieve information from a non-subscribing provider with a range of products or services similar to a product or service of said non-subscribing provider, said similar products or services being advertised by subscribing providers. Said range could comprise a ranking of products or services based on levels of charges levied to the subscribing providers. Non-subscribing providers are preferably informed, for example by e-mail, when there have been potential customers looking for their product or service.

The present invention also provides a system for facilitating the retrieval of information concerning products and/or services provided by a plurality of mutually unrelated providers, comprising a single internet site, the address of which internet site may be included in each of a plurality of advertisements for the respective products and/or services, said internet site being accessible by consumers and including means for retrieving said information.

Said advertisements may include television advertisements, radio advertisements, and advertisements in printed media.

Preferably, said internet site further includes means for retrieving information concerning categories of products and/or services provided by all subscribing providers.

Advantageously, said internet site further includes information relating to one of more of the advertisements themselves. Said information may include music titles, hyperlinks to stores to buy a recording of the theme tune, hyperlinks to stores to purchase a product shown incidentally in the advertisement as an accessory, filming locations and hyperlinks to websites advertising holidays in said filming locations.

Said internet site may even comprise downloadable files comprising complete copies of the advertisements.

It will thus be seen that the invention provides a valuable means of generating direct sales of products and services advertised via various media.

Revenue is immediately obtainable from advertisers and linked sites. Additionally, the internet site of the invention will be a popular website so it can host its own advertising.

Preferably, the system of the invention includes a database comprising personal details including at least the names and e-mail addresses of consumers who have retrieved information, the database being categorized according to the products and/or services which said information concerns. This will give an extremely powerful marketing database.

### BRIEF DESCRIPTION OF THE DRAWING

In order that the present invention may be more readily understood, a particular embodiment thereof will now be described, by way of example only, with reference to the accompanying drawing, the single figure of which is a block diagram of a system according to the invention.

### DETAILED DESCRIPTION OF THE PREFERRED EMBODIMENT

In this example, a system for facilitating information retrieval comprises a website 1 having a particular address. The website includes information retrieval means 2 comprising hyperlinks 3 to a number of sites belonging to subscribing advertisers of products and services.

In order to subscribe to the website, an advertiser or advertising agency or other person or company uses a password to access the website and is presented with an on-screen form. This form enables the subscriber to input information relating to their advertisements, such as the name of the product or service, the category of the produce or service, the date and circumstances of the presentation of the advertisement, the identity of the creator of the advertisement, details of the theme music, location etc, one or more pictures of the advertisement and keywords describing the content of the advertisement.

Subscribing advertisers may be invited to include the address of the website 1 in their advertisements 4, for example stating that further information is available from the website. However, it is not essential that the address of the website 1 is included in the advertisements 4. As an alternative, a logo or other means may be used to identify the website 1. Indeed, no identification at all is necessary. However, if subscribers are charged, in order to encourage them to identify the website 1 in their advertisements 4, those doing so could be charged a lower amount than those who do not.

If a consumer sees a product advertised that he or she finds interesting but is unable to remember details of the product, even after the first viewing the consumer can access the website 1, where he or she will be reminded and full details can be found. It is unnecessary to remember the particular product's web site address or even its brand name or category—these can always be found at the website 1, as long as some key information identifying the advertisement is remembered, matching the keywords previously uploaded in association with the respective advertisement.

Thus the website 1 provides a means for locating an advertisement when only very little thereof is remembered, as commonly occurs.

Advertisers not subscribing to the website 1 are at a significant disadvantage when compared to those in the same product category who have subscribed. If a consumer looks for a non-subscribing advertiser the information retrieval means 2 will present him or her with a range of similar products being advertised by subscribers (there is a ranking in this range, based on fees charged to the subscribers). Non-subscribers will be e-mailed that there have been potential customers looking for their product.

A consumer searching for a particular category of product, for example a car, is able to log on to the website 1 to see all the cars currently being advertised.

Additionally the site includes a part 5 giving information 6 about the advertisements themselves (often as appealing as the products). The advertisement information 6 may include music titles, links to stores to buy a recording of the theme tune and/or links to stores to purchase a product shown incidentally in the advertisement as an accessory. Filming locations and links to package holidays in the area can also be provided.

Providing copyright is satisfied, a visitor can also download, from part 5, files 7 embodying complete copies of the advertisements 4 onto DVD for his or her own entertainment.

In a history section 8 of part 5 famous advertisements will be available, many of which are artworks in their own right, with associated information and downloading ability.

The most valuable part of the business of the invention is likely to be its consumer database 9. Subscribers wishing to see product details will be asked for their name and e-mail address, as a minimum, which will be logged on the database 9 neatly segregated by category of product chosen.

The invention is not limited to the specific embodiment which has been described above, and modifications thereto, which do not depart from the spirit and scope of the invention as defined by the following claims, will readily occur to those skilled in the art.

I claim:

1. A method of facilitating the retrieval of information concerning products and/or services provided by a plurality of mutually unrelated providers and advertised in respective advertisements having content, comprising providing a single internet site including means for retrieving said information, said internet site being accessible by consumers, the information retrieving means operating to retrieve information concerning a particular one of said products and/or services when a part of the content of the respective advertisement is identified by a consumer.

2. The method according to claim 1, wherein said means for retrieving the information comprises a plurality of hyperlinks to websites of the providers.

3. The method according to claim 1, wherein said internet site includes information concerning the products and services.

4. The method according to claim 1, wherein a consumer wishing to retrieve said information is required to input personal details including at least his or her name and e-mail address, and said details are added to a database.

5. The method according to claim 4, wherein consumers in the database are categorized according to their products or services of interest.

6. The method according to claim 1, including a step of presenting any consumer attempting to retrieve information from a non-subscribing provider with a range of products or services similar to a product or service of said non-subscribing provider, said similar products or services being provided by subscribing providers.

7. The method according to claim 6, wherein said range comprises a ranking of products or services based on levels of charges levied to the subscribing providers.

8. The method according to claim 6, wherein a non-subscribing provider is informed when a consumer has attempted to retrieve information concerning a product or service of said non-subscribing provider.

9. The method according to claim 1, wherein a consumer inputting a brand name or one or more keywords relating to a specific advertisement is only directed towards information concerning a product or service featured in said advertisement.

10. The method according to claim 1, wherein said internet site is identifiable by identifying information included in one or more of said advertisements.

11. The method according to claim 10, wherein said identifying information comprises an address of said internet site.

12. A method of facilitating the retrieval of information concerning products and/or services having names and being provided by a plurality of mutually unrelated providers and advertised in respective advertisements, comprising providing a single internet site including means for retrieving said information, said internet site being accessible by consumers, the information retrieving means operating to retrieve information concerning a particular one of said products and/or services when the name of said one product or service is identified by a consumer.

13. The method according to claim 12, wherein said means for retrieving the information comprises a plurality of hyperlinks to websites of the providers.

14. The method according to claim 12, wherein a consumer wishing to retrieve said information is required to input personal details including at least his or her name and e-mail address, and said details are added to a database.

15. The method according to claim 14, wherein consumers in the database are categorized according to their products or services of interest.

16. The method according to claim 12, including a step of presenting any consumer attempting to retrieve information from a non-subscribing provider with a range of products or services similar to a product or service of said non-subscribing provider, said similar products or services being provided by subscribing providers.

17. The method according to claim 16, wherein said range comprises a ranking of products or services based on levels of charges levied to the subscribing providers.

18. The method according to claim 16, wherein a non-subscribing provider is informed when a consumer has attempted to retrieve information concerning a product or service of said non-subscribing provider.

19. The method according to claim 12, wherein a consumer inputting a brand name or one or more keywords relating to a specific advertisement is only directed towards information concerning a product or service featured in said advertisement.

20. The method according to claim 12, wherein said internet site is identifiable by identifying information included in one or more of said advertisements.

21. The method according to claim 20, wherein said identifying information comprises an address of said internet site.

22. A method of facilitating the retrieval of information concerning products and/or services provided by a plurality of mutually unrelated providers, comprising providing a single internet site including means for retrieving said information, said internet site being accessible by consumers, and identifying information identifying said internet site being included in each of a plurality of advertisements for the respective products and/or services.

23. The method according to claim 22, wherein said identifying information comprises an address of said internet site.

24. A method of doing business, comprising providing a single internet site including means for retrieving information concerning products and/or services provided by a plurality of mutually unrelated providers, said internet site being accessible by consumers, allowing providers to subscribe to said internet side, and allowing the subscribing providers to include an address of said internet site in each of a plurality of advertisements for the respective products and/or services.

25. A system for facilitating the retrieval of information concerning products and/or services provided by a plurality of mutually unrelated providers and advertised in respective advertisements having content, comprising a single internet site including means for retrieving said information, said internet site being accessible by consumers, the information retrieving means operating to retrieve information concerning a particular one of said products and/or services when a part of the content of the respective advertisement is identified by a consumer.

26. The system according to claim 25, wherein said advertisements comprise at least one of television advertisements, radio advertisements, and advertisements in printed media.

27. The system according to claim 25, wherein said means for retrieving information is operable to retrieve information concerning categories of products and/or services provided by all subscribing providers.

28. The system according to claim 25, wherein said internet site further includes advertisement information relating to at least one of the advertisements as such.

29. The system according to claim 28, wherein said advertisement information includes at least one of a music title, a hyperlink to a website to buy a recording of a theme tune of the advertisement, a hyperlink to a website to buy a product featured incidentally in the advertisement as an accessory, a filming location and a hyperlink to a website advertising a holiday in a filming location.

30. The system according to claim 25, wherein said internet site comprises at least one downloadable file embodying a complete copy of an advertisement.

31. The system according to claim 25, further including a database comprising personal details including at least names and e-mail addresses of consumers who have retrieved information.

32. The system according to claim 25, wherein the database is categorized according to the products and/or services which said retrieved information concerns.

33. The system according to claim 25, wherein said internet site is identifiable by identifying information included in one or more of said advertisements.

34. The system according to claim 33, wherein said identifying information comprises an address of said internet site.
